(19) United States
(12) Patent Application Publication
(10) Pub. No.: US 2008/0084163 A1
(43) Pub. Date: Apr. 10, 2008

(54) Dielectric barrier discharge lamp

(76) Inventors: Shinichiro HATAOKA, Osaka (JP); Masaki HIROHASHI, Tokyo (JP)

Correspondence Address: WENDEROTH, LIND & PONACK L.L.P., 2033 K. STREET, NW, SUITE 800, WASHINGTON, DC, 20006, US

(21) Appl. No.: 11/979,011

(22) Filed: Oct. 30, 2007

Related U.S. Application Data
(63) Continuation of application No. PCT/JP07/53532, filed on Feb. 26, 2007.
(63) Continuation of application No. PCT/JP2007/058509, filed on Apr. 19, 2007.

(30) Foreign Application Priority Data
Apr. 17, 2006 (JP) 2006-113347

(51) Int. Cl. H01J 61/54; H01J 17/44

(52) U.S. Cl. 313/594

(57) ABSTRACT

A dielectric barrier discharge lamp has a high efficiency as well as high brightness. A distance between an external electrode and a gastight container of the dielectric barrier discharge lamp decreases with a distance from an internal electrode in a longitudinal direction of the gastight container. A surface area of the external electrode per unit length thereof decreases with the distance from the internal electrode in the longitudinal direction of the gastight container. The electrostatic capacity formed between the gastight container and the external electrode is substantially constant in the longitudinal direction of the gastight container or decreases with the distance in the longitudinal direction.

This is a continuous application of International Application No. PCT/JP2007/53532, filed Feb. 26, 2007.

### BACKGROUND OF THE INVENTION

The present invention relates to a dielectric barrier discharge lamp for use as a light source device such as a light source for general illumination, light source for illuminating an original in apparatuses including a facsimile machine and copier, or light source for a backlight device for illuminating a liquid crystal display panel.

Recently, in addition to lamps using mercury as a discharge medium (referred to hereinbelow as mercury-containing lamps), lamps using no mercury (referred to hereinbelow as mercury-free lamps) have been widely studied as lamps or light source devices for light sources of backlight devices and the like. The light source devices provide with mercury-free lamps are preferable for reasons in view of environmental standpoint as well as for small fluctuation of light emission intensity under an effect of changes in temperature with time.

One of known mercury-free lamps for the light source devices comprises a cylindrical gastight container enclosing a rare gas as a discharge medium, an internal electrode disposed inside the gastight container, and an external electrode disposed outside the gastight container. A voltage applied between the internal electrode and the external electrode plasmanizes the rare gas to generate light. However, such internal-external electrode type dielectric barrier discharge lamp has a problem where brightness in a longitudinal direction of the lamp is non-uniform or uneven.

Various research have been conducted to improve brightness uniformity in the longitudinal direction of the lamp. For example, Japanese Patent Application Laid-open Publication No. 2001-325919 discloses that the brightness uniformity is improved by increasing an electrostatic capacity formed between the gastight container and the external electrode with a distance from the internal electrode in the longitudinal diction. FIG. 10 shows an example of arrangement disclosed in Japanese Patent Application Laid-open Publication No. 2001-325919. A discharge container 1 comprises an elongated transparent gastight container 1a, an insertion wire 1b sealed at one end of the transparent gastight container 1a, an internal electrode 1c formed at a distal end of the insertion wire 1b and sealed inside the transparent gastight container 1a, a fluorescent layer 1d, and a discharge medium comprising a rare gas as the main components and filled in a discharge space 1e inside the transparent gastight container 1a. A dielectric layer 2 is provided on an outer circumferential surface of the transparent gastight container 1a. A dielectric constant of the dielectric layer 2 is low at a point adjacent to the internal electrode 1c and increases with a distance from the internal electrode 1c. This arrangement achieves the electrostatic capacity increasing with the distance from the internal electrode in the longitudinal direction. Further, the external electrode 3 is made from a metallic foil and attached as a circular-arc layer to the outer circumferential surface of the dielectric layer 2.

FIG. 11 is a graph showing a light emission intensity distribution in the lamp of the above-described arrangement. In FIG. 11, a position in the axial direction of the discharge lamp is plotted against a horizontal ordinate. A reference character “A” denotes one end portion on the internal electrode side, and a reference character “B” denotes other end portion away from the internal electrode. A light emission intensity (relative values) is plotted against a vertical ordinate. The curve “C” shown by a solid line represents measurement results obtained with a configuration in which the capacity increases with the distance from the internal electrode in the longitudinal direction, and the curve “D” shown by a broken line represents measurement results obtained with a configuration in which the capacity is substantially constant in the longitudinal direction. As clearly indicated in the graph, the capacity increasing with the distance from the internal electrode in the longitudinal direction improves the brightness uniformity.

### SUMMARY OF THE INVENTION

However, test results obtained by the present inventors showed that, although improving brightness uniformity, the arrangement of Japanese Patent Application Laid-open Publication No. 2001-325919 decreases efficiency. In particular, the decrease in efficiency tends to become significant as a lamp length increases. It is an object of the present invention to provide a dielectric barrier discharge lamp achieves both of a high efficiency and high brightness uniformity.

A first aspect of the present invention provides a dielectric barrier discharge lamp comprising, at least one gastight container, a discharge medium comprising a rare gas and filled in the gastight container, an internal electrode disposed inside the gastight container, and an external electrode disposed outside the gastight container with a space. A distance between the external electrode and the gastight container decreases with a distance from the internal electrode in a longitudinal direction of the gastight container. Further, a surface area of the external electrode per unit length thereof decreases with the distance from the internal electrode in the longitudinal direction of the gastight container. Furthermore an electrostatic capacity of the space between the gastight container and the external electrode is substantially constant in the longitudinal direction of the gastight container, or decreases with the distance from the internal electrode in the longitudinal direction of the gastight container.

Specifically, satisfied regarding to the dielectric barrier discharge lamp is the formula S/d≧S′/d′, where “d” denotes a distance between the external electrode and the gastight container at a first point adjacent to the internal electrode, “S” denotes a surface area of the external electrode per unit length thereof at the first point, “d′” denotes the distance between the external electrode and the gastight container at a second point away from the internal electrode, and “S′” denotes the surface area of the external electrode per unit length thereof at the second point.

A second aspect of the present invention provides a liquid crystal display device comprising, the above-mentioned dielectric barrier discharge lamp, optical sheets disposed adjacent to the dielectric barrier discharge lamp, and a liquid crystal display panel disposed above the optical sheets.

A gradient or change of the distance between the gastight container and external electrode with respect to the distance from the internal electrode in the longitudinal direction of the gastight container realizes the arrangement in which the electrostatic capacity formed in the space between the light emitting tube and the external electrode is substantially constant in the longitudinal direction of the gastight container or decreases with the distance from the internal electrode in the longitudinal direction of the gastight container, resulting in the dielectric barrier discharge lamp with both of the high efficiency and high brightness uniformity.

### BRIEF DESCRIPTION OF THE DRAWINGS

Other objects and characteristics of the present invention shall be clarified by the following description on the preferred embodiments with reference to the accompanying drawings.

FIG. 1A is a schematic vertical cross-sectional view of a dielectric barrier discharge lamp according to a first embodiment of the present invention;

FIG. 1B is a plan view of an external electrode of the dielectric barrier discharge lamp according to the first embodiment;

FIG. 2A is a schematic vertical cross-sectional view of a dielectric barrier discharge lamp according to a second embodiment of the present invention;

FIG. 2B is a plan view of an external electrode of the dielectric barrier discharge lamp according to the second embodiment;

FIG. 3A is a schematic vertical cross-sectional view of a dielectric barrier discharge lamp of Comparative Example 1;

FIG. 3B is a plan view of an external electrode of the dielectric barrier discharge lamp of Comparative Example 1;

FIG. 4A is a schematic vertical cross-sectional view of a dielectric barrier discharge lamp of Comparative Example 2;

FIG. 4B is a plan view of an external electrode of the dielectric barrier discharge lamp of Comparative Example 2;

FIG. 5 is a graph showing a brightness distribution in examples and comparative examples;

FIG. 6 is a graph showing an efficiency distribution in examples and comparative examples;

FIG. 7A is a schematic plan view of a brightness measurement apparatus;

FIG. 7B is a cross-sectional view along a VII-VII line;

FIG. 8A is a schematic vertical cross-sectional view of the lamp for explaining a method for measuring efficiency;

FIG. 8B is a plan view of an external electrode for explaining a method for measuring efficiency;

FIG. 9 is a V-Q Lissajous waveform figure;

FIG. 10A is a vertical sectional view of a conventional dielectric barrier discharge lamp;

FIG. 10B is a transverse sectional view of the conventional dielectric barrier discharge lamp; and

FIG. 11 is a graph showing a light emission intensity distribution in the conventional dielectric barrier discharge lamp.

### DESCRIPTION OF THE PREFERRED EMBODIMENTS

Embodiments of the present invention will be described below in detail with reference to the appended drawings.

### First Embodiment

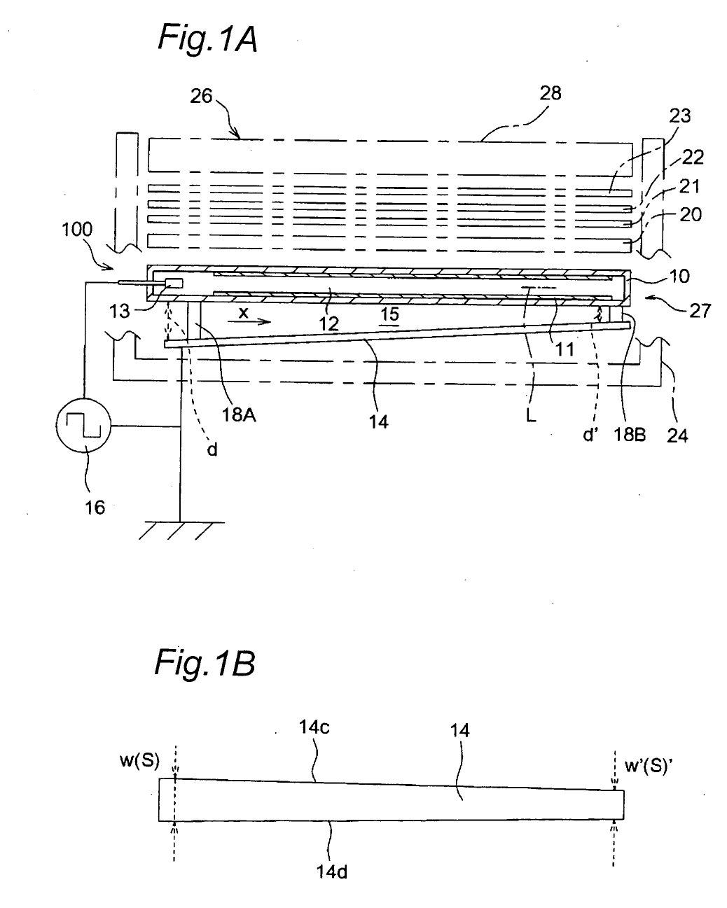

FIG. 1 shows a dielectric barrier discharge lamp (referred to hereinbelow simply as “lamp”) 100 of a first embodiment of the present invention. FIG. 1A is a vertical cross-sectional view, and FIG. 1B is a plan view of an external electrode. The lamp 100 of the present embodiment constitutes a part of a backlight device 27 of a liquid crystal display device 26 as will be described later in detail.

The lamp 100 of the present embodiment comprises a transparent gastight container 10 having an elongated cylinder-like form with a round cross section, a fluorescent layer 11 formed on an inner side of the gastight container 10, and a discharge medium 12 comprising a rare gas as main component and filled in the gastight container 10. An internal electrode 13 having a short column-like form is sealed to one end portion inside the gastight container 10. Further, an external electrode 14 having a flat plate-like form is disposed on an outside of the gastight container 10. The external electrode 14 is a thin long flat plate extending along a longitudinal direction of the gastight container 10 (direction in which an axial line or a tube axis “L” of the gastight container 10 extends). The external electrode 14 is disposed on holding members 18A, 18B made from an insulating material such as a silicone rubber and separated by a gap from the gastight container 10. An air layer 15 is provided in the space between the lamp 100 and the external electrode 14. By applying a high voltage with a drive circuit 16 between the internal electrode 13 and the external electrode 14 of the lamp 100, a dielectric barrier discharge is initiated in the discharge medium 12, thereby light is emitted. It is preferred that a surface of the external electrode 14 is subjected to a mirror-surface reflection processing, so that a high quantity of outgoing light is obtained even without disposing a high-reflection sheet on the surface of the external electrode 14.

A distance “d” between the external electrode 14 and the gastight container 10 is set to decrease with a distance from the internal electrode 13 in the longitudinal direction of the gastight container 10. Specifically, as shown in FIG. 1A, the distance “d” between the gastight container 10 and the external electrode 14 is set such that the distance “d′” at a position away from the internal electrode 13 is less than the distance “d” at a point adjacent to the internal electrode 13. In other words, relationship “d>d′” is satisfied. In particular, in the present embodiment, the external electrode 14 having the plate-like form with a flat surface facing the gastight container 10 and the external electrode 14 is disposed obliquely with respect to the tube axis “L” of the gastight container 10. As a result, the distance “d” decreases with the distance from the internal electrode 13 in the longitudinal direction of the gastight container 10. Therefore, the distance “d” decreases proportionally to the distance “x” from the internal electrode 13 in the longitudinal direction of the gastight container 10. However, it is not necessary for the distance “d” to decrease proportionally to the distance “x”, as long as that the distance “d” decreases with the increase in distance from the internal electrode 13 in the longitudinal direction of the gastight container 10.

A surface area “S” of the external electrode 14 per unit length thereof is set to decrease with the distance from the internal electrode 13 in the longitudinal direction of the gastight container 10. More specifically, as shown in FIG. 1B, the surface area “S” (width “w”) of the external electrode 14 per unit length thereof (unit dimension in the longitudinal direction of the gastight container 10) is set such that the surface area “S′” (width w′) away from the internal electrode 13 is less than the surface area “S” (width “w”) adjacent to the internal electrode 13. In other words, relationship “S>S′ (w>w′)” is satisfied. In particular, in the present embodiment, both side edges 14c, 14d in plain view of the external electrode 14 are linear, and the width “w” of the external electrode 14 decreases proportionally to the distance “x” from the internal electrode 13 in the longitudinal direction of the gastight container 10. However, it is not necessary for the width “w” of the external electrode 14 to decrease proportionally to the distance “x”, as long as that the width decreases with the increase in distance from the internal electrode 13 in the longitudinal direction of the gastight container 10.

Further, the distance “d” between the external electrode 14 and the gastight container 10 and the surface area “S” of the external electrode 14 per unit length thereof are set such that the electrostatic capacity of the above-mentioned air layer 15 is substantially constant in the longitudinal direction of the gastight container 10 or decreases with the distance from the internal electrode 13 in the longitudinal direction of the gastight container 10. Generally, electrostatic capacity is proportional to a surface area and inversely proportional to a distance. Therefore, the distance “d” and surface area “S” at the position adjacent to the internal electrode 13, and the distance “d′” and surface area “S′” at the position away from the internal electrode 13 are set to satisfy, for example, the following relationship (1).
S/d≧S′/d′ (1)

By setting the distance “d” between the external electrode 14 and the gastight container 10 and the surface area “S” of the external electrode 14 per unit length thereof in the above-described manner, it is possible to improve brightness uniformity of the dielectric barrier discharge lamp, without decreasing the efficiency, as will be described later in greater detail with reference to specific examples.

The lamp 100 of the present embodiment constitutes part of a backlight device 27 as a flat light source device for a liquid crystal display device 26 and is disposed on a rear surface side of a diffuser plate 20. A plurality of lamps 100 is disposed in a direction perpendicular to the sheet of FIG. 1 such that the gastight containers 10 are parallel to each other. A diffusion sheet 21 for light scattering, prism sheet 22 for limiting orientation of emitted light, and polarization sheet 23 for restricting polarization of the emitted light are disposed in a stacked configuration on a front surface side of the diffuser plate 20. The lamp 100, diffuser plate 20, and sheets 21 to 23 are accommodated inside a housing 24. A liquid crystal display panel 28 is disposed on a front surface side of the polarization sheet 23. Light emitted by the lamp 100 is emitted from the front surface of the diffuser plate 20, is transmitted via the sheets 21 to 23, and then illuminates a liquid-crystal panel 28 from a rear surface side thereof.

### Second Embodiment

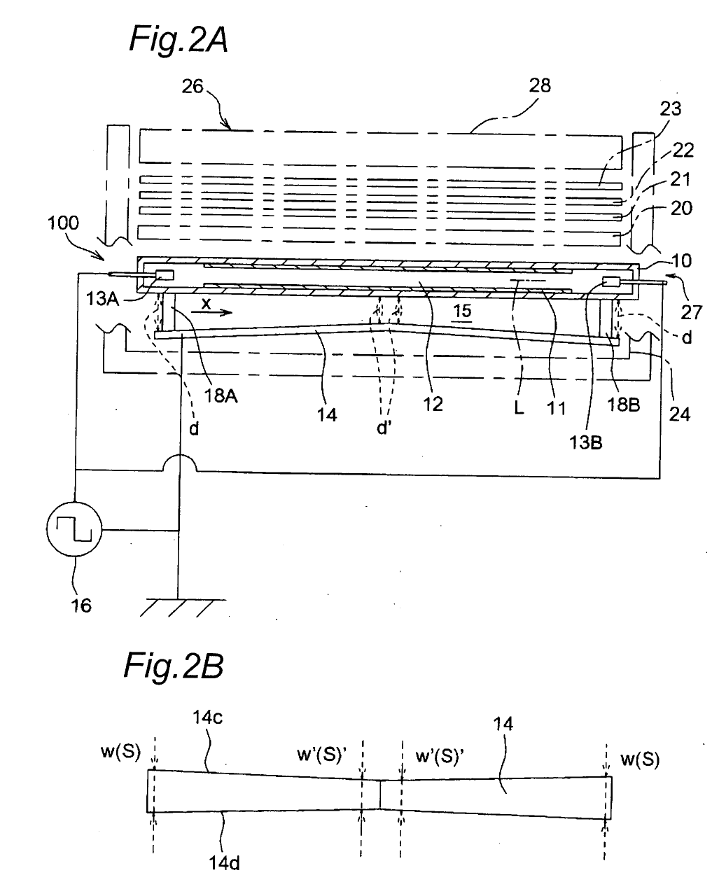

In the first embodiment, a single internal electrode 13 is sealed only at one end of the gastight container 10, but in the second embodiment shown in FIG. 2A, the lamp 100 is provided with two internal electrodes 13A, 13B, and each of the internal electrodes 13A, 13B is sealed at the respective end inside the gastight container 10. The distance “d” between the external electrode 14 and the gastight container 10, and the surface area “S” (width “w”) of the external electrode 14 per unit length thereof are set in the same manner as those in the first embodiment. Specifically, both of the distance “d” and surface area “S” decrease with the distance from the internal electrodes 13A, 13B toward a central portion in the longitudinal direction of the gastight container 10. Further, the relationship represented by formula (1) above is satisfied for each of the internal electrodes 13A, 13B.

Because other arrangements and operation of the second embodiment are same as those of the first embodiment, the same elements are assigned with identical reference symbols and explanation thereof is herein omitted.

### EXAMPLES

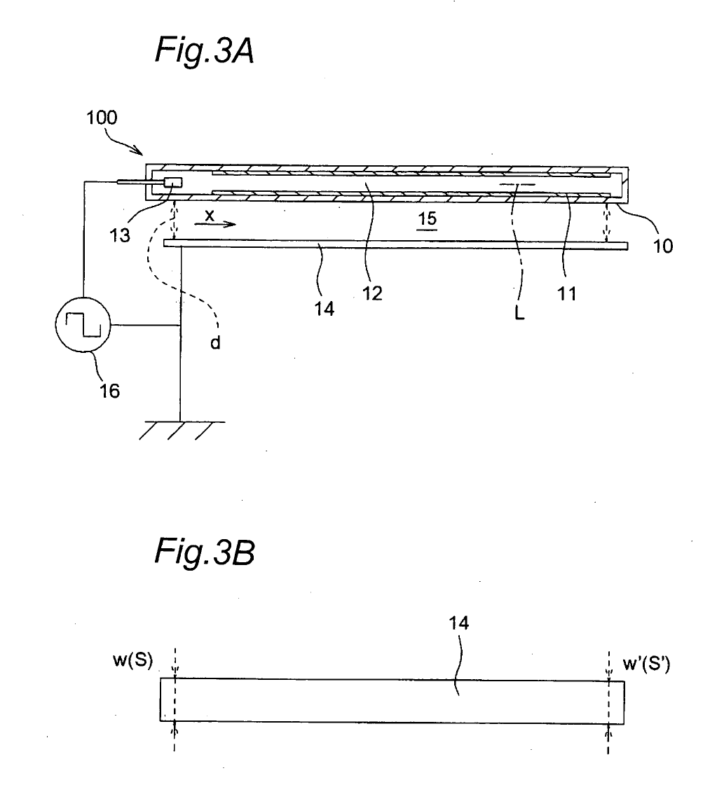

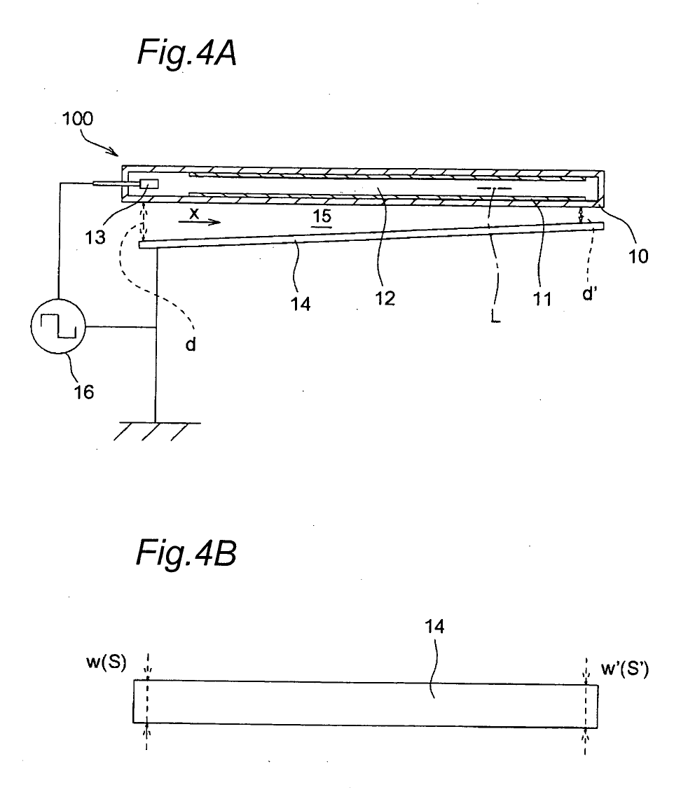

Two lamps 100 of the first embodiment shown in FIG. 1A were actually fabricated (Examples 1, 2), and tests were performed to measure brightness distribution and efficiency distribution. For comparison a conventional lamp (Comparative Example 1 shown in FIGS. 3A, 3B, and Comparative Example 2 shown in FIGS. 4A, 4B) were fabricated, and the brightness distribution and efficiency distribution were similarly measured.

Following features were common for Examples 1, 2 and Comparative Examples 1, 2. A straight tube made from borosilicate glass with an almost circular cross-sectional shape was used as the gastight container 10. The straight tube had an inner diameter of 2.0 mm, an outer diameter of 3.0 mm, and a length of 350 mm. The fluorescent layer 11 was formed on the inner surface of the gastight container 10 by using a mixture of a blue fluorescent substance BaMgAl₁₀O₁₇:Eu, green fluorescent substance LaPO₄:Ce,Tb, and red fluorescent substance (Y,Gd)BO₃:Eu. A mixed gas comprising xenon 60% and argon 40% was filled as the discharge medium 12 under a pressure of 20 kPa. The internal electrode 13 was formed from nickel, and the external electrode 14 was formed from aluminum.

The distance “d” between the gastight container 10 and the external electrode 14, and the surface area “S” (width “w”) of the external electrode 14 per unit length thereof differed among Examples 1, 2 and Comparative Examples 1, 2 as described below. Specific numerical values are listed in Table 1.

TABLE 1

| | Position | | | | | |
|---|---|---|---|---|---|---|
| | Adjacent To | | | | | |
| | Internal Electrode | | | Position Away From | | |
| | 13 | | | Internal Electrode 13 | | |
| | w | d | | w′ | | |
| | (mm) | (mm) | w/d | (mm) | d′ (mm) | w′/d′ |
| Example 1 | 15 | 3.1 | 4.8 | 10 | 2.1 | 4.8 |
| Example 2 | 15 | 3.1 | 4.8 | 5 | 2.1 | 2.4 |
| Comparative | 15 | 3.1 | 4.8 | 15 | 3.1 | 4.8 |
| example 1 | | | | | | |
| Comparative | 15 | 3.1 | 4.8 | 15 | 2.1 | 7.1 |
| Example 2 | | | | | | |

Referring to FIG. 1 and Table 1, in Examples 1, 2, a gradient of the distance “d” and surface area “S” (width “w”) was created in the longitudinal direction, and the distance “d” and surface area “S” (width “w”) decreased with the distance from the internal electrode 13 in the longitudinal direction of the gastight container 10.

In the lamp 100 of Example 1, both of the distance “d” and surface area “S” (width “w”) decreased with the distance from the internal electrode 13 in the longitudinal direction of the gastight container 10, thereby electrostatic capacity of the air layer 15 was substantially constant in the longitudinal direction of the gastight container 10. Specifically, setting values are “d=3.1 mm” and “w=15 mm” at the point adjacent to the internal electrode 13, whereas the setting values are “d′=2.1 mm” and “w′=10 mm” at the point away from the internal electrode 13. Thus, the relationship “w/d=w′/d′ (S/d=S′/d′)” is satisfied. This means that the electrostatic capacity is substantially constant at the positions adjacent to and away from the internal electrode 13.

The lamp 100 of Example 2 was configured similarly to the lamp of Example 1 so that both of the distance “d” and surface area “S” (width “w”) decreased with the distance from the internal electrode 13 in the longitudinal direction of the gastight container 10. However, by decreasing the surface area “S′” (width “w′”) at the position away from the internal electrode 13 with respect to that of Example 1, a configuration was obtained in which the electrostatic capacity of the air layer 15 decreased with the distance from the internal electrode 13 in the longitudinal direction of the gastight container 10. Specifically, setting values are “d=3.1 mm” and “w=15 mm” at the position adjacent to the internal electrode 13, whereas the setting values are “d′=2.1 mm” and “w′=5 mm” at the position away from the internal electrode 13. Thus, the relationship “w/d>w′/d′ (S/d>S′/d′)” is satisfied. This means that the electrostatic capacity at the position away from the internal electrode 13 is less than that at the position adjacent to the internal electrode 13.

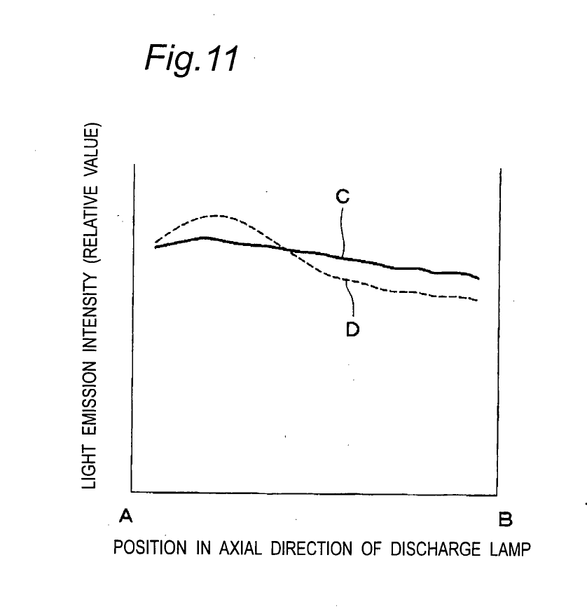

The lamp 100 of Comparative Example 1 was configured such that both of the distance “d” and surface area “S” (width “w”) were constant in the longitudinal direction of the gastight container 10 as shown in FIG. 3, thereby the electrostatic capacity was constant in the longitudinal direction of the gastight container 10. The lamp 100 of Comparative Example 1 is equivalent to the lamp shown by a numerical symbol “D” in the above-described FIG. 11. Specifically, the distance “d” between the gastight container 10 and external electrode 14 was “d=d′=3.1 mm”, and the width “w” of the external electrode 14 was “w=w′=15 mm”.

The lamp 100 of Comparative Example 2 was configured such that a gradient of the distance “d” was created in the longitudinal direction of the gastight container 10 as shown in FIG. 4, thereby the distance “d” decreased with the distance from the internal electrode 13. On the other hand, the surface area “S” (width “w”) was constant in the longitudinal direction of the gastight container 10. By setting the distance “d2 and surface “S” in such a manner, the electrostatic capacity of the air layer 15 was set to increase with the distance from the internal electrode 13 in the longitudinal direction of the gastight container 10. The lamp of comparative Example 2 is equivalent to the lamp shown by a numerical symbol “C” in the above-described FIG. 11. Specifically, the distance “d” between the gastight container 10 and external electrode 14 was “d=3.1 mm” at the position adjacent to the internal electrode and “d′=2.1 mm” at the position away from the internal electrode. Further, the width “w” of the external electrode 14 was constant in the longitudinal direction, i.e., “w=w′=15 mm” was satisfied.

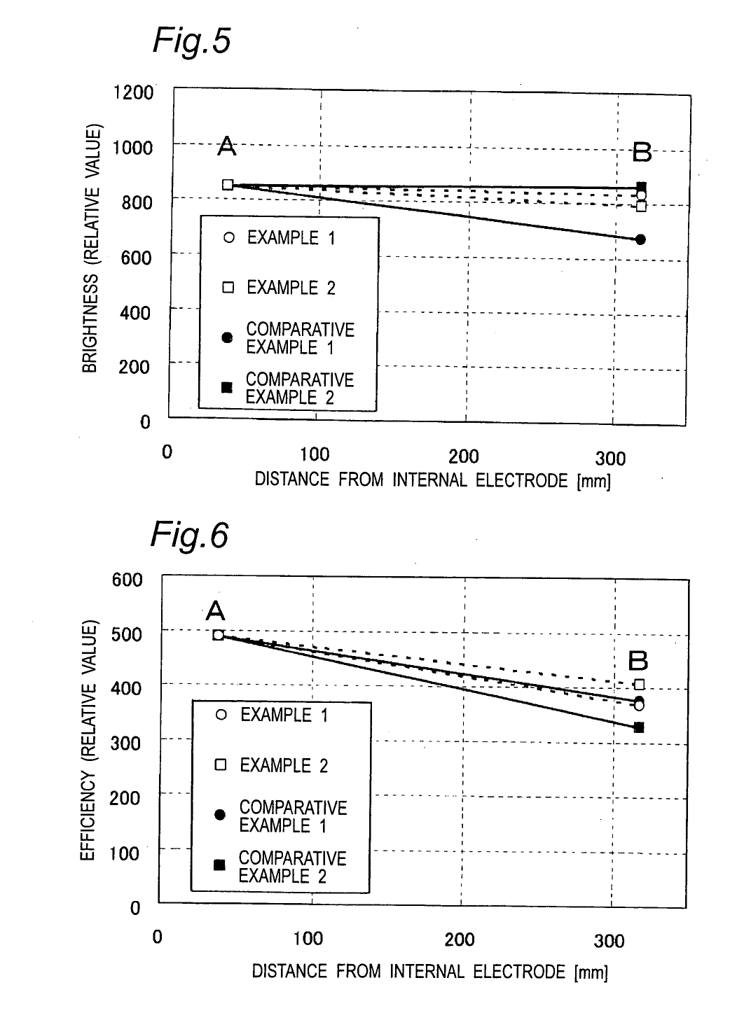

The lamps of Examples 1, 2 and Comparative Examples 1, 2 were lighted with a high-voltage pulse power source (SBP-5K-HF-1, HAIDENLABORATORY Japan) as a drive circuit 16, and brightness and efficiency in the longitudinal direction were measured. The drive waveform during the measurements was positive-negative alternating rectangular pulses, and the voltage had a peak-to-peak value of several kilovolts. FIG. 5 shows the relationship between the brightness and distance in the longitudinal direction from the internal electrode 13. FIG. 6 shows the relationship between the efficiency and distance in the longitudinal direction from the internal electrode 13. In both cases, the measurements were performed in two points: point “A” at a distance of 40 mm and point “B” at a distance of 320 mm in the longitudinal direction from the internal electrode 13. Specific methods for measuring the brightness and efficiency are described later in details.

Firstly, measurement results obtained in Examples 1, 2 and Comparative Example 2 (FIG. 4) are compared. FIG. 5 shows that the brightness distribution in Examples 1, 2 is identical or similar to that of Comparative Example 2. FIG. 6 demonstrates that the efficiency distributions of Examples 1, 2 are improved over that of Comparative Example 2. At the point “B”, efficiency ratios of Examples 1, 2 are respectively improved over that of Comparative Example 2 by approximately 9% and 25%. Thus, the degree of improvement of efficiency distribution is more significant in the configuration with w/d>w′/d′ (configuration in which the electrostatic capacity decreases with the distance from the internal electrode 13 in the longitudinal direction of the gastight container 10) than in the configuration with w/d=w′/d′ (configuration in which the electrostatic capacity is constant in the longitudinal direction of the gastight container 10).

Measurement results obtained in Examples 1, 2 and Comparative Example 1 (FIG. 3) are then compared. FIG. 5 shows that the brightness distribution in Examples 1, 2 is greatly improved over that of Comparative Example 1. FIG. 6 demonstrates that the efficiency distributions of Examples 1, 2 are identical to or better than that of Comparative Example 1.

The above-described measurement results demonstrate that by employing a configuration as in Examples 1, 2 in which (a) the distance “d” between the external electrode 14 and the gastight container 10 decreases and (b) the surface area of the external electrode 14 per unit length thereof is decreased so that the electrostatic is constant or decreases with the distance from the internal electrode 13, the efficiency can be improved significantly, while improving the brightness distribution. In other words, with such configuration, a barrier discharge lamp with a high efficiency as well as a high brightness uniformity can be realized.

The brightness distributions of Comparative Example 2 and Examples 1, 2 are improved significantly over that of Comparative Example 1 (FIG. 5), but the efficiency of Comparative Example 2 is lower than those of Examples 1, 2 (FIG. 5). The reason for this can be inferred as follows.

It generally known that the efficiency of the dielectric barrier discharge increases with the decrease of lamp current density. Here, a virtual capacitor at the points “A” and “B” of the lamp 100 of Comparative Example 2 will be considered. At the point “B”, the distance “d′” between the gastight container 10 and the external electrode 14 is less than the distance “d” at the point A, and the width “w” (surface area “S” per unit length) is the same at the points “A” and “B”. Because electrostatic capacitance of a capacitor is proportional to a surface area and inversely proportional to a distance between electrodes, the electrostatic capacity per unit length at the point “B” is lager than that at the point “A”. This result means that electric charge accumulated at the point “B” is larger than that at the point “A” and therefore supposing that a cross sectional area of the gastight container 10 is constant, the lamp current density generated at the point “B” becomes larger than that generated at the point “A”. This supposedly results in that the efficiency at the point “B” decreases with respect to that at the point “A” in Comparative Example 2. Contrarily, in Examples 1, 2, not only the distance “d” between the gastight container 10 and the external electrode 14 decreases from the point “A” toward the point “B”, but also the width “w” of the external electrode 14 decreases (the surface area “S” of the external electrode 14 per unit length thereof decreases). By these arrangements, in Examples 1, 2, the electrostatic capacity at the points “A” and “B” is substantially constant (Example 1) or the electrostatic capacity at the point “B” decreases with respect to that at the point “A” (Example 2). This means that the lamp current density generated at the point “B” is equal to or less than that generated at the point “A”. This supposedly causes that the efficiency at point “B” practically does not decrease with respect to that at the point “A” in Examples 1, 2.

As described above, in Examples 1, 2, brightness distribution is improved over that in Comparative Example 1. In Comparative Example 1, the distance “d” between the external electrode 14 and gastight container 10 is the same at the points “A” and “B”, and electric field intensity at the point “B” located away from the internal electrode 13 is equal to that at the point “A” located adjacent to the internal electrode 13. Contrarily, in examples 1, 2, the distance “d” between the external electrode 14 and gastight container 10 decreases from the point “A” toward the point “B”, and the electric field intensity increased with the distance from the internal electrode 13. The improvement in brightness distribution in Examples 1, 2 is supposedly due to the distribution of electric field intensity in the longitudinal direction of the gastight container 10.

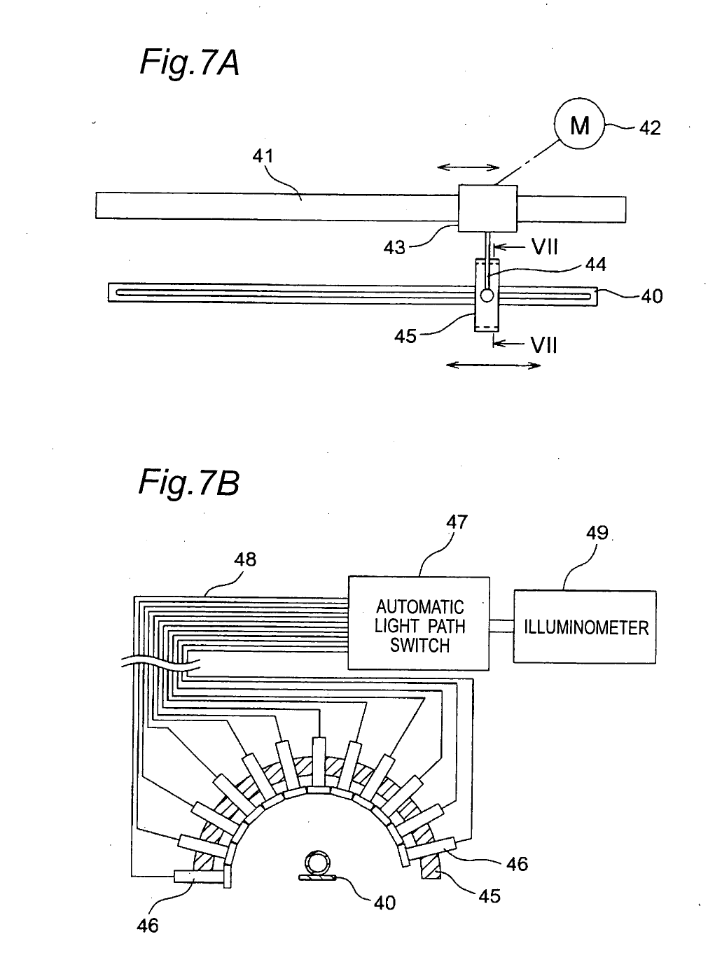

A measurement method for brightness distribution will be described below in detail. FIGS. 7A, 7B show a brightness measurement apparatus used for above mentioned examples. The brightness measurement apparatus comprises an elongated holding stand 40 extending in a horizontal direction for holding thereupon the lamp 100 in a lighted state and a linear guiding rail 41 extending parallel to the holding stand 40 (parallel to the tube axis “L” of the gastight container 10 of the lamp 100). A slider 43 that can move reciprocatingly when driven by a motor 42 is disposed on the linear guiding rail 41. A head holding portion 45 of a semi-annular shape is mechanically connected to the slider 43 via a connecting arm 44. A central axis of the head holding portion 45 is aligned with the tube axis L of the lamp 100 on the holding stand 40. A total of twelve light-receiving heads 46 are disposed on the head holding portion 45 so as to surround the gastight container 10 of the lamp 100 in a circumferential direction of the lamp 100. An automatic light path switch 47 successively switches the twelve light-receiving heads 46 such that one of the light-receiving head 46 sequentially transmits received light via corresponding optical fiber 48. As a result, brightness of the lamp 100 at one position on a tube axis “L” can be measured. Further, because the head holding portion 45 can be moved together with the slider 43 to any position on the tube axis “L”, the brightness of the lamp 100 in any position on the tube axis “L” can be measured. Furthermore, by adding up (integrating) values of the brightness of the lamp 100 in the circumferential direction in individual positions on the tube axis “L”, a total light flux value of comparative lamp 100 is obtained.

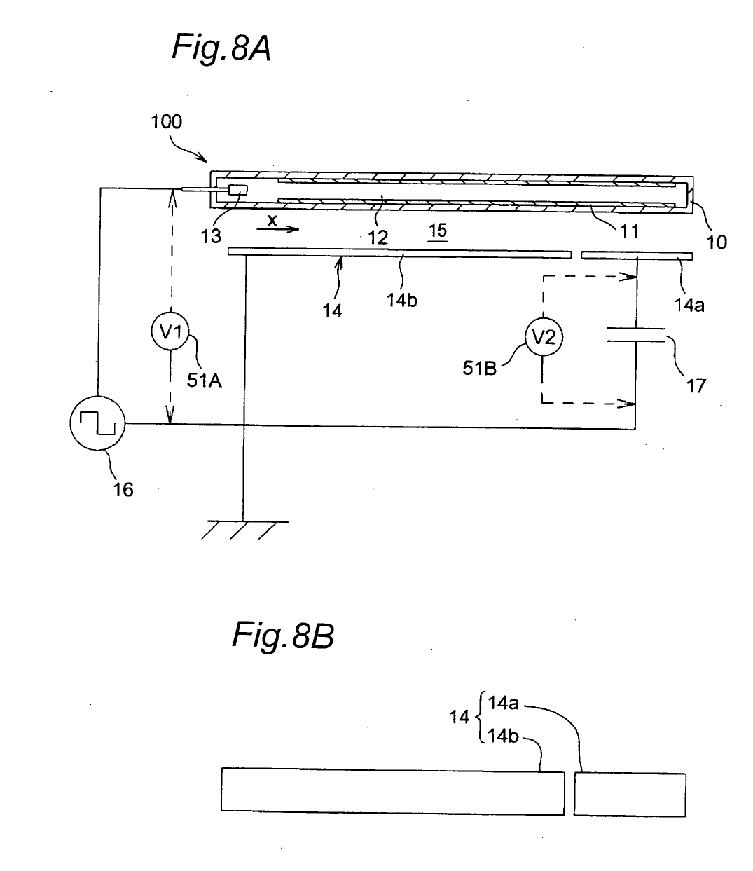

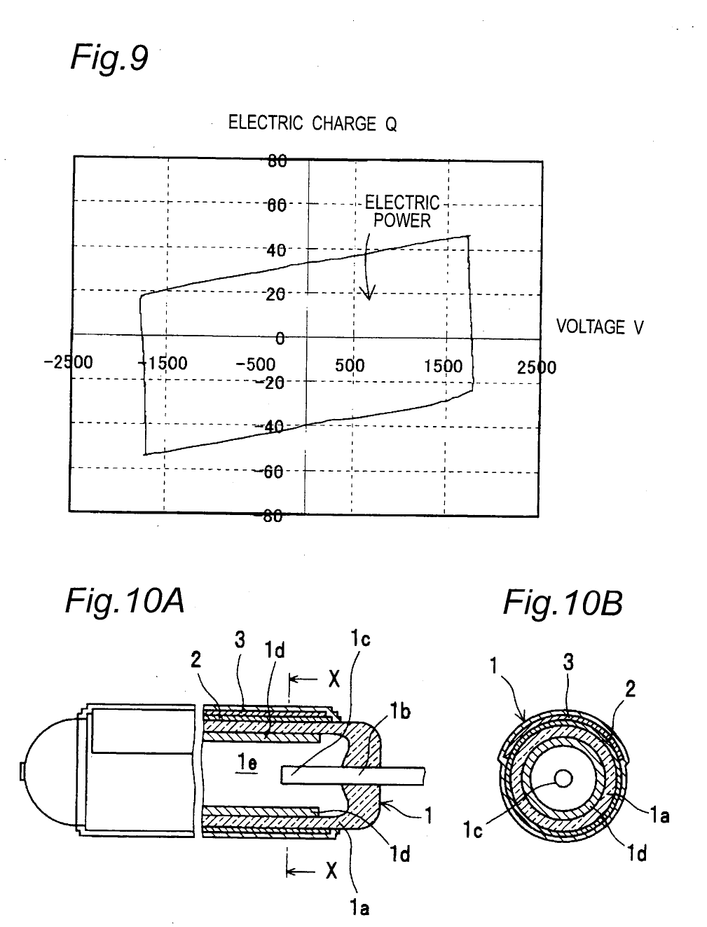

Then, a measurement method for efficiency distribution will be described below. A method for measuring the efficiency in each position in the axial line direction the lamp as shown in FIG. 6 was not established, and therefore conducting such measurements is difficult. The present inventors designed a new method by which power can be easily measured in each position, thereby enabling the measurement of efficiency in each position as shown in FIG. 6. FIG. 8 illustrates the principle of the measurement method designed by the present inventors. An external electrode 14 is divided into a portion 14b and a remaining portion 14a in a location where the efficiency is to be measured. A capacitor 17 is electrically connected in series to the external electrode 14b at the measurement location. A voltage probe 51A is electrically connected between the internal electrode 13 and the capacitor 17, and a voltage probe 51B is connected to both ends of the capacitor 17. In order to decrease an effect on the lamp 100, the capacitor 17 has an electrostatic capacity sufficiently larger than that of the lamp 100. When measurements illustrated by FIG. 6 were conducted, the electrostatic capacity of the lamp 100 was several tens of picofarads, whereas the capacitor of the capacitor 17 was approximately several tens of nanofarads. When a high voltage is applied between the lamp 100 and capacitor 17 with a drive circuit 16 and the lamp 100 is lighted, voltages “V12 and “V2” are measured. A voltage V applied to the lamp 100 is calculated from the measured voltages “V1” and “V2” (V=V1−V2). Further, an electric charge Q accumulated at the measurement position is calculated from the electrostatic capacity “C” of the capacitor 17 and the voltage “V2” (Q=C×V2). FIG. 9 shows a V-Q Lissajous figure in which the voltage “V” and electric change “Q” that were thus found are respectively plotted against the ordinate and abscissa. The lamp power is equivalent to the surface area surrounded by a linear figure in FIG. 9 (surface area corresponding to one period of an alternative voltage applied by the drive circuit 16) and an be found by the following formula (2).
(Lamp Power)=(Surface area of one Period)×(Drive frequency) (2)

Further, where the light output in the measurement location is measured at the same time by using the above-described brightness measurement device (FIG. 8), the efficiency in the measurement location can be calculated by the following formula (3).
(Efficiency at measurement location)=(Light output)/(Lamp power) (3)

With the above-described procedure, the efficiency can be measured in each position on the tube axis “L”. As a result, it could be found out that in the configuration of Comparative Example 2 (FIG. 4), the efficiency decreases at the point “B” away from the internal electrode 13. Further, the configuration of the present invention (Examples 1, 2) could be confirmed to be capable of improving the efficiency distribution, while maintaining high brightness uniformity.

Alternatives of the above-described first embodiment (Examples 1, 2) and second embodiment will be described below.

Although the embodiments employees the gastight container 10 having the straight pipe-like shape made from the borosilicate glass, but the present invention is not limited to such container. For example, quartz glass, soda glass, or lead glass also may be used as a material for the gastight container 10. Further, the shape is not limited to a straight tube shape. For example, L-like shaped, U-like shaped, T-like shaped container or a rectangular container may be used.

No specific limitation is placed on the type of fluorescent 11 and it may be another material such as used in fluorescent lamps for general illumination and plasma displays.

Any at least one gas comprising a rare gas as the main component may be used as the discharge medium 12, and the gas used in the embodiments is not limiting. The pressure of gas enclosed in the gastight container 10, that is, the pressure inside the gastight container 10 is preferably about 0.1 kPa to 76 kPa.

The internal electrode 13 can be formed not only from nickel, but also from other metals, for example, tungsten and niobium. The surface of the internal electrode 13 may be partially or entirely coated with a metal oxide such as cerium oxide, barium oxide, and strontium oxide. By using such metal oxide layer, the ignition initiation voltage can be reduced and degradation of electrodes by ion bombardment can be prevented.

The material of the external electrode 14 is not limited to aluminum, and this electrode can be formed from a transparent conductive structure comprising a metal such as copper and stainless steel, or tin oxide, indium oxide, or the like as the main component. Further, by using the external electrode 14 that was subjected to a mirror-surface reflection processing, it is possible to obtain a high quantity of light emitted from the light source device, without disposing a high-reflectance sheet on the surface of the external electrode 14. Further, means for holding the external electrode 14 and the gastight container 10 at a distance from each other is not particularly limited to the holding members 18A, 18B of the embodiments. The shape of the external electrode 14 is not limited to a flat plate shape of constant thickness. The important factor regarding the external electrode 14 is not the shape itself thereof but that it designed such that the equivalent electrostatic capacity in the longitudinal direction is substantially constant or decreases with the distance from the internal electrode 13. The space between the external electrode 14 and the gastight container 10 is not limited to the air layer 15 and can be filled with another gas or a solid material.

The lamp according to the present invention can be used not only in the backlight device 27 of the liquid crystal display device 26, but also in light sources for general illumination, light sources for illuminating originals in facsimile machines and copiers, and the like.

Although the present invention has been fully described in conjunction with preferred embodiments thereof with reference to the accompanying drawings, various changes and modifications are possible for those skilled in the art. Therefore, such changes and modifications should be construed as included in the present invention unless they depart from the intention and scope of the invention as defined by the appended claims.

What is claimed is:

1. A dielectric barrier discharge lamp, comprising:
at least one gastight container;
a discharge medium comprising a rare gas and filled in the gastight container;
an internal electrode disposed inside the gastight container; and
an external electrode disposed outside the gastight container with a space,
wherein a distance between the external electrode and the gastight container decreases with a distance from the internal electrode in a longitudinal direction of the gastight container,
wherein a surface area of the external electrode per unit length thereof decreases with the distance from the internal electrode in the longitudinal direction of the gastight container, and
wherein an electrostatic capacity of the space between the gastight container and the external electrode is substantially constant in the longitudinal direction of the gastight container, or decreases with the distance from the internal electrode in the longitudinal direction of the gastight container.

2. The dielectric barrier discharge lamp according to claim 1, wherein the following formula is satisfied
S/d≧S′/d′
where d denotes a distance between the external electrode and the gastight container at a first point adjacent to the internal electrode,
S denotes a surface area of the external electrode per unit length thereof at the first point,
d′ denotes the distance between the external electrode and the gastight container at a second point away from the internal electrode, and
S′ denotes the surface area of the external electrode per unit length thereof at the second point.

3. A liquid crystal display device, comprising:
the dielectric barrier discharge lamp according to claim 1;
optical sheets disposed adjacent to the dielectric barrier discharge lamp; and
a liquid crystal display panel disposed above the optical sheets.
